(19) United States
(12) Patent Application Publication
(10) Pub. No.: US 2007/0223070 A1
(43) Pub. Date: Sep. 27, 2007

(54) Holographic Master Production and Replication

(75) Inventor: Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,715

(22) PCT Filed: May 9, 2005
(86) PCT No.: PCT/IB05/51508

§ 371 Date: Nov. 6, 2006

(30) Foreign Application Priority Data
May 12, 2004 (EP) 04300273.2

(51) Int. Cl. G11B 7/0065

(52) U.S. Cl. 359/1

(57) ABSTRACT

The invention relates to an optical holographic master production device. This device comprises means for receiving a master (302a), a radiation source (300) for producing a radiation beam and a reflective spatial light modulator (303) placed on the other side of the receiving means with respect to the radiation source. The invention also relates to an associated replication device.

### FIELD OF THE INVENTION

The present invention relates to holographic master production and replication. The invention particularly relates to an optical device for manufacturing a master and an optical device for replicating said master.

The present invention is particularly relevant for a ROM holographic manufacturing apparatus.

### BACKGROUND OF THE INVENTION

A ROM information carrier is an information carrier that can only be read out. Such an information carrier is usually manufactured in a factory, and then read out by a user. For example, a CD or a DVD is manufactured by means of a stamper. The stamper comprises pits and lands that have to be recorded on the CD or DVD. The CD or DVD is embossed by means of the stamper. In holographic data storage, embossing is not possible because the data are stored in a volume, and not only at the surface of the holographic medium. A solution for manufacturing a ROM holographic medium consists in manufacturing a master, and then replicating said master, for example in 1000, 10000 or 100000 copies.

An optical holographic master production device is known from H. J. Coufal, D. Psaltis, G. T. Sincerbox (Eds.), ‘Holographic data storage’, Springer series in optical sciences, (2000). FIG. 1 shows such a master production device. This master production device comprises a radiation source 100, a collimator 101, a beam splitter 102, a spatial light modulator 103, a lens 104, a deflector 106 and a telescope 107. The master production device is intended to record data in a master 105.

During recording of a hologram in the master 105, half of the radiation beam generated by the radiation source 100 is sent towards the spatial light modulator 103 by means of the beam splitter 102. This portion of the radiation beam is called the signal beam. Half of the radiation beam generated by the radiation source 100 is deflected towards the telescope 107 by means of the deflector 106. This portion of the radiation beam is called the reference beam. The signal beam is spatially modulated by means of the spatial light modulator 103. The spatial light modulator 103 comprises transmissive areas and absorbent areas, which corresponds to zero and one data-bits of a hologram to be recorded. After the signal beam has passed through the spatial light modulator 103, it carries the signal to be recorded in the master 105, i.e. the hologram to be recorded. The signal beam is then focused on the master 105 by means of the lens 104.

The reference beam is also focused on the master 105 by means of the telescope 107. The hologram is thus recorded in the master 105, in the form of an interference pattern as a result of interference between the signal beam and the reference beam. Once a hologram has been recorded in the master 105, another hologram is recorded at a same location of the master 105. To this end, data corresponding to this hologram are sent to the spatial light modulator 103. The deflector 106 is rotated so that the angle of the reference signal with respect to the master 105 is modified. The telescope 107 is used to keep the reference beam at the same position while rotating the deflector 106. An interference pattern is thus recorded with a different pattern at a same location of the master 105. This is called angle multiplexing. A same location of the master 105 where a plurality of holograms is recorded is called a book.

Alternatively, the wavelength of the radiation beam may be tuned in order to record different holograms in a same book. This is called wavelength multiplexing.

Once a master has been recorded, it can be replicated by means of a holographic replication device. Such a replication device is described in FIG. 2. This replication device comprises a radiation source 200, a collimator 201, a beam splitter 202, a first mirror 203, a second mirror 204, a third mirror 205 and an imaging lens 206. This replication device is intended to replicate the master 105 in a replication medium 207.

Half of the radiation beam generated by the radiation source 200 is sent towards the replication medium 207 by means of the beam splitter 202. Half of the radiation beam generated by the radiation source 200 is deflected towards the master 105 by means of the first, second and third mirrors 203, 204 and 205. The portion of the beam that reaches the master 105 is diffracted by the various books recorded in the master 105. A reconstructed signal is thus created, which corresponds to holograms recorded in the master 105. The reconstructed signal beam is then focused on the replication medium 207 by means of the imaging lens 206. The holograms are thus replicated in the replication medium 207, as a result of interference between the reconstructed signal beam and the portion of the beam generated by the radiation source 200 that is deflected towards the replication medium 207.

A drawback of the holographic master production device of FIG. 1 is that it requires two optical branches for generating the reference beam and the signal beam; a drawback of the associated holographic replication device of FIG. 2 is that it requires two optical branches for generating the reference beam and the reconstructed signal beam. This makes these devices bulky and expensive, and makes the manufacture of such devices long and complicated.

### SUMMARY OF THE INVENTION

It is an object of the invention to provide a holographic master production device and an associated replication device, which are more compact and easier to manufacture.

To this end, the invention proposes an optical holographic master production device comprising means for receiving a master, a radiation source for producing a radiation beam and a reflective spatial light modulator placed on the other side of the receiving means with respect to the radiation source.

According to the invention, a reflective spatial light modulator is used. During master production, the radiation beam is directed towards the master, then spatially modulated and reflected back towards the master. As a consequence, a reference beam and a signal beam interfere inside the master, which creates an information pattern inside said master. The holographic master production device in accordance with the invention thus does not require separate optical branches for generating the signal beam and the reference beam. It is thus relatively compact and easy to manufacture.

Advantageously, the radiation beam has a wavelength which can be tuned, for recording different holograms at a same location of the recording medium. This allows for wavelength multiplexing, which increases the data capacity that can be recorded in the master, and thus in the replicated holographic medium.

Advantageously, the master production device further comprises a first lens between the radiation source and the receiving means and a second lens between the receiving means and the reflective spatial light modulator. The size of the recorded hologram reduces due to the use of the lenses, which increases the data capacity that can be recorded in the master. Furthermore, the use of the lenses allows interference of spherical waves inside the master. As a consequence, shift multiplexing is possible, which increases the data capacity further.

The invention also relates to an optical holographic replication device for replicating a master produced by means of a master production device in accordance with the invention. Such an optical holographic replication device comprises means for receiving said master, a radiation source for producing a radiation beam and means for receiving a recording medium, said means for receiving said recording medium being placed between the radiation source and the means for receiving said master. As a reflective spatial light modulator has been used for producing the master, the information pattern recorded in the master is such that a radiation beam that impinges on said master is diffracted back in the opposite direction. As a consequence, if a recording medium is placed between the radiation source and the master, the radiation beam produced by the radiation source and the signal beam diffracted by the master interfere inside the recording medium. This leads to an information pattern recorded in the recording medium. The master is thus replicated.

The invention also relates to an optical holographic replication device for replicating a master produced by means of a master production device in accordance with an advantageous embodiment of the invention. Such an optical holographic replication device comprises means for receiving said master, a radiation source for producing a radiation beam, a lens between the radiation source and the means for receiving said master, and means for receiving a recording medium, said means for receiving said recording medium being placed between said lens and the means for receiving said master.

The invention also relates to an optical holographic master production and replication device. Such a device comprises means for receiving a master, a radiation source for producing a radiation beam, a reflective spatial light modulator placed on the other side of the receiving means with respect to the radiation source and means for receiving a recording medium, said means for receiving said recording medium being placed between the radiation source and the means for receiving said master.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a holographic master production device in accordance with the prior art;

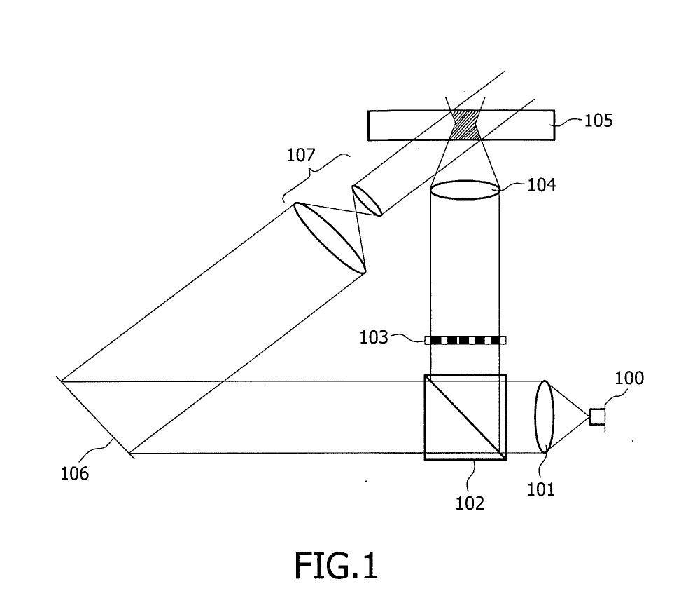

FIG. 2 shows a holographic replication device in accordance with the prior art;

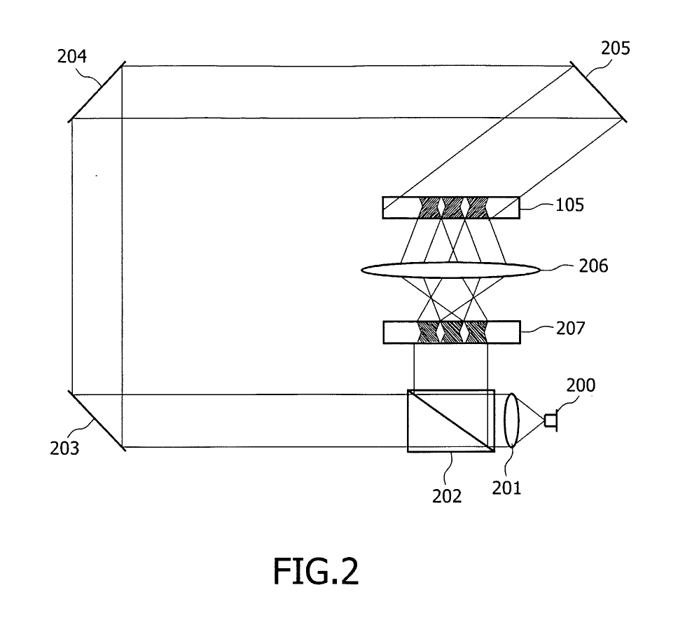

FIG. 3a shows a holographic master production device in accordance with the invention and FIG. 3b shows a holographic master production device in accordance with an advantageous embodiment of the invention;

FIG. 4a shows a holographic replication device in accordance with the invention and FIG. 4b shows a holographic replication device in accordance with an advantageous embodiment of the invention.

### DETAILED DESCRIPTION OF THE INVENTION

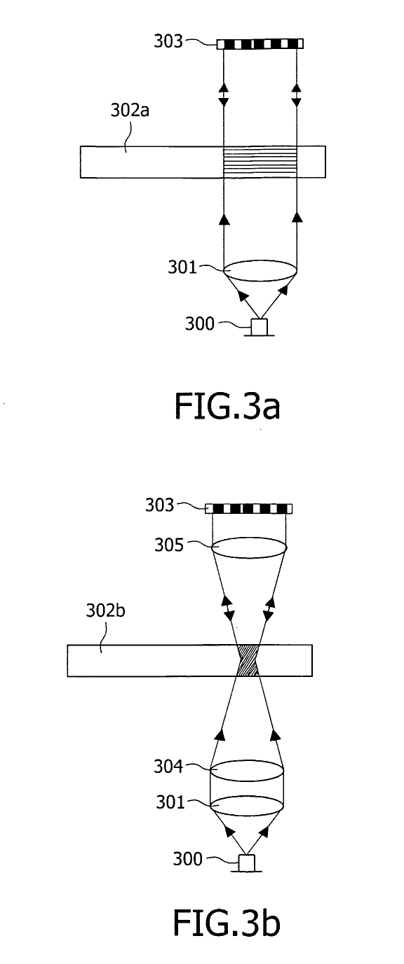

A holographic master production device in accordance with the invention is depicted in FIG. 3a. This master production device comprises a radiation source 300, a collimator 301 and a reflective spatial light modulator 303. This master production device is intended to record holographic data in a master 302a. The optical device also comprises means for receiving the master, which are not shown in FIG. 3a. These receiving means are, for example, a table on which the recording medium can be put. A table such as those conventionally used in CD or DVD players can be used for example.

During master production, the radiation source 300 generates a radiation beam, which is transformed into a parallel beam by means of the collimator 301. This parallel beam then passes through the master 302a and reaches the reflective spatial light modulator 303. A reflected signal is thus reflected, which carries the information sent to the reflective spatial light modulator 303. This reflected signal then reaches the master 302a, where interference takes place with the beam that comes from the radiation source 300. This interference creates an information pattern in the master 302a, and the hologram to be recorded is thus recorded. The beam that directly comes from the radiation source 300 plays the role of a reference beam, whereas the beam coming from the reflective spatial light modulator 303 plays the role of a signal beam.

In the master production device in accordance with the invention, the signal beam and the reference beam thus are generated with the same optical branch. As a consequence, the master production device in accordance with the invention is much more compact than the master production device in accordance with the prior art.

The reflective spatial light modulator 303 may be, for example, a reflective ferroelectric Liquid Crystal on Silicon (FLCOS) spatial light modulator. Such a spatial light modulator is commercialized, inter alia, by the companies “Boulder Nonlinear Systems” and “Displaytech”. The reflective spatial light modulator 303 may also be a reflective Digital Micromirror Device (DMD) spatial light modulator. Such a spatial light modulator is commercialized, inter alia, by the company “Productivity Systems”. The reflective spatial light modulator 303 may also be a combination of a transmissive spatial light modulator and a mirror, although this solution is less preferred, because the efficiency of a transmissive spatial light modulator is lower than the efficiency of a reflective spatial light modulator.

Once a hologram has been recorded, another hologram may be recorded by modifying the wavelength of the radiation beam. The master production device in accordance with the invention is particularly advantageous for wavelength multiplexing. Actually, in order to record a relatively high number of holograms in a same book of the master 302a, the wavelength selectivity should be as low as possible. The wavelength selectivity represents the gap between two successive wavelengths that can be used for recording two holograms with acceptable crosstalk. It is known from H. J. Coufal, D. Psaltis, G. T. Sincerbox (Eds.), ‘Holographic data storage’, Springer series in optical sciences, (2000) that the wavelength selectivity is : Δλ=(λ² cos θₛ)/2 L sin²[0.5(θ_{f}+θₛ)], where λ is the wavelength, L the thickness of the master, θ_{f} and θₛ the angles between the reference beam and the signal beam with the normal of the master, respectively. In the master production device of the prior art, the angle θ_{f} between the reference beam and the normal of the master is about π/4, whereas this angle is null in the master production device in accordance with the invention. It can be calculated that the wavelength selectivity is about 6.8 times better in the master production device in accordance with the invention than in the master production device of the prior art.

This means that the number of holograms that can be recorded per book is about 6.8 times higher in the master production device in accordance with the invention than in the master production device of the prior art. As a consequence, the data capacity that is reached with a ROM medium replicated by means of a master produced in accordance with the invention is increased.

Once a book has been recorded in the master 302a, another book may be recorded by moving the master 302a with respect to the optical pick-up unit comprising the radiation source 300, the collimator 301 and the reflective spatial light modulator 303. Alternatively, the optical pick-up unit is moved with respect to the master 302a, in a direction parallel to the master 302a.

FIG. 3b shows a master production device in accordance with an advantageous embodiment of the invention. This optical device comprises, in addition to elements already depicted with reference to FIG. 3a, a first lens 304 and a second lens 305. In FIG. 3b, the master is noted 302b. The first lens 304 is arranged between the radiation source 300 and the master 302b, and the second lens 305 is arranged between the master 302b and the reflective spatial light modulator 303.

During master production, the radiation beam produced by the radiation source 300 is focused in the master 302b by means of the first lens 304. A spherical wave beam is thus focussed in the master 304. This spherical wave beam is then made parallel by means of the second lens 305, and then reaches the reflective spatial light modulator 303 where a signal beam is created. On the way back from the spatial light modulator 303, the signal beam is focused in the master 302b by means of the second lens 305. As a consequence, a spherical wave signal beam interferes with a spherical wave reference beam inside the master 302b, and an information pattern is created, which corresponds to the hologram to be recorded.

The fact that spherical waves beams interfere inside the master 302b allows for shift multiplexing. Shift multiplexing consists in recording a set of holograms by shifting the master with respect to the optical pick-up unit. Once a hologram or a book has been recorded at a given location of the master, the master is moved over a distance that is less that the width of a hologram. Shift multiplexing is only possible when spherical waves interfere, and would thus not be possible with the optical device of FIG. 3a.

Advantageously, a combination of shift multiplexing and wavelength multiplexing is used for recording data in the master 302b. For example, a book is recorded at a certain location by tuning the wavelength of the radiation beam generated by the radiation source 300. Once this book has been recorded, the master 302b is shifted with respect to the optical pick-up unit, over a distance that is smaller than the width of a book. Another book is then recorded by tuning the wavelength of the radiation beam.

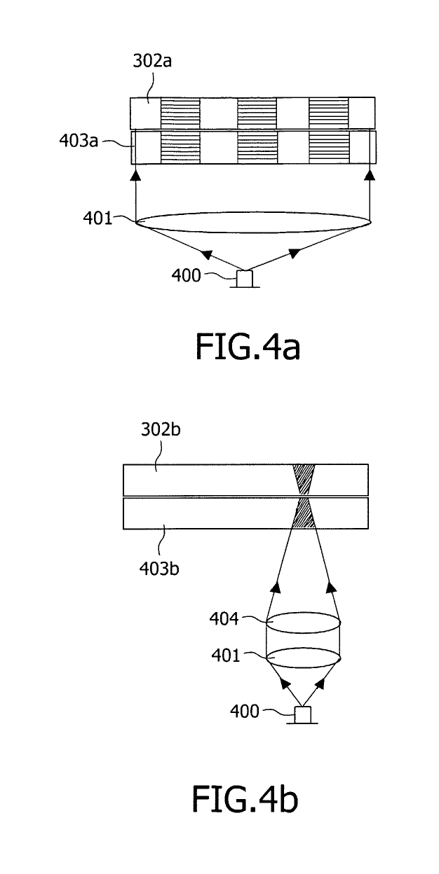

FIG. 4a shows a replication device in accordance with the invention. This replication device comprises a radiation source 400 and a collimator 401. This replication. device is intended to replicate the master 302a recorded by means of the device of FIG. 3a. The replication consists in duplicating the data recorded in the master 302a in a recording medium 403a. The replication device of FIG. 4a comprises means for receiving the master 302b and means for receiving the recording medium 403a, which are not shown in FIG. 4a. These receiving means are, for example, a table on which the recording medium can be put. A table such as those conventionally used in CD or DVD players can be used for example.

During replication, a radiation beam having a given wavelength produced by the radiation source 400 is made parallel by means of the collimator 401, passes through the recording medium 403a and reaches the master 302a. This beam is reflected by the information patterns recorded in said master 302a with the same wavelength. A reconstructed signal beam is thus created, which carries the recorded information corresponding to the holograms recorded in the master 302a with the same wavelength.

This reconstructed signal beam interferes with the beam generated by the radiation source 400, inside the recording medium 403a. As a consequence, information patterns are created in the recording medium 403a, which correspond to the information recorded in the master 302a with the given wavelength. The wavelength of the radiation beam is then tuned in order to record the holograms recorded in the master with other wavelengths. The master is thus replicated in the recording medium 403a. The replication time is very low, because the complete information recorded in the master 302a with a given wavelength can be replicated in one time, whatever the number of books in the master 302a. The replication time only depends on the number of wavelengths that have been used for recording the master 302a.

The replication device in accordance with the invention has the further advantage that no DC-offset is recorded in the recording medium 403a. Actually, a DC-offset is written when two separate optical branches are used for generating the reference beam and the reconstructed signal beam. The presence of a DC-offset reduces the data capacity of the replicated recording medium. In the replication device in accordance with the invention, a single optical branch is used, so that no DC-offset is recorded during replication.

It should be noted that the master production device of FIG. 3a and the replication device of FIG. 4a may be combined in a single master production and replication device. Actually, the master production device of FIG. 3a may further comprise means for receiving a recording medium to be replicated, which receiving means are arranged between the radiation source 300 and the means for receiving the master 302a. During master production, no recording medium is inserted into the means for receiving the recording medium, whereas a recording medium is inserted during replication.

FIG. 4b shows a replication device in accordance with an advantageous embodiment of the invention. This optical device is intended to replicate the master 302b recorded with the master production device of FIG. 3b, in order to make a recording medium 403b. It comprises the radiation source 400, the collimator 401, a lens 404, as well as means for receiving the master 302b and means for receiving the recording medium 403b, which are not shown in FIG. 4b.

During replication, a radiation beam is focussed on the master 302b. This creates a reconstructed signal beam, which interferes with the beam produced by the radiation source 400, inside the recording medium 403b. A hologram is thus recorded in the recording medium 403b. In order to record another hologram at the same place, the wavelength is tuned. The information of the master is replicated book per book inside the recording medium 403b.

The replication device of FIG. 4b could also be combined with the master production device of FIG. 3b in a single master production and replication device, in a similar way as the way described in the description of FIG. 4a.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic master production device comprising means for receiving a master (302a, 302b), a radiation source (300) for producing a radiation beam and a reflective spatial light modulator (303) placed on the other side of the receiving means with respect to the radiation source.

2. An optical holographic master production device as claimed in claim 1, wherein said radiation beam has a wavelength which can be tuned for recording different holograms at a same location of the recording medium.

3. An optical holographic master production device as claimed in claim 1, further comprising a first lens (304) between the radiation source and the receiving means and a second lens (305) between the receiving means and the reflective spatial light modulator.

4. An optical holographic replication device for replicating a master (302a) produced by means of the device of claim 1, said holographic replication device comprising means for receiving said master, a radiation source (400) for producing a radiation beam and means for receiving a recording medium (403a), said means for receiving said recording medium being placed between the radiation source and the means for receiving said master.

5. An optical holographic replication device for replicating a master (302b) produced by means of the device of claim 3, said holographic replication device comprising means for receiving said master (302b), a radiation source (400) for producing a radiation beam, a lens (404) between the radiation source and the means for receiving said master, and means for receiving a recording medium (403b), said means for receiving said recording medium being placed between said lens and the means for receiving said master.

6. An optical holographic master production and replication device comprising means for receiving a master, a radiation source for producing a radiation beam, a reflective spatial light modulator placed on the other side of the receiving means with respect to the radiation source and means for receiving a recording medium, said means for receiving said recording medium being placed between the radiation source and the means for receiving said master.
